(19) United States
(12) Patent Application Publication
(10) Pub. No.: US 2004/0005059 A1
(43) Pub. Date: Jan. 8, 2004

(54) Correspondence education system and correspondence education method

(76) Inventors: Yoshihiko Suzuki, Tokyo (JP); Takeshi Funahashi, Saitama (JP); Akimichi Kurihara, Kanagawa (JP)

Correspondence Address: FROMMER LAWRENCE & HANG LLP, 745 FIFTH AVENUE, NEW YORK, NY, 10151, US

(21) Appl. No.: 10/287,119

(22) Filed: Nov. 4, 2002

(30) Foreign Application Priority Data
Nov. 5, 2001 (JP) 2001-339627

(51) Int. Cl. H04L 9/00; H04L 9/32; H04K 1/00

(52) U.S. Cl. 380/277; 713/186; 713/202

(57) ABSTRACT

A correspondence education system in which a terminal apparatus and an information processing apparatus are connected to each other via a network includes: authentication communication means disposed in the terminal apparatus for performing authentication processing on the basis of human body characteristics of a student and transmitting a predetermined authentication signal to the information processing apparatus via the network only when a positive result of the authentication processing is obtained; and control means disposed in the information processing apparatus for transmitting teaching material data representing lecture contents according to a predetermined educational program to the terminal apparatus via the network on the basis of the authentication signal received from the authentication communication means.

### BACKGROUND OF THE INVENTION

The present invention relates to a correspondence education system and a correspondence education method, and is suitable for application to a network system such as the Internet, for example.

Conventionally, each student enrolled in a correspondence course of a university or the like proceeds with learning while exchanging lecture contents related to all courses to be completed by the student with the school, which is a provider of the lecture contents, by using communication means such as radio, television, or mail.

The Web (that is, WWW: World Wide Web), or an information network that links together various information within servers distributed on the Internet and thereby enables search for the information has recently been widely used as an information service. It is to be considered that using the Web, a server of a school can exchange various data related to lecture contents with a personal terminal of a client, or a student to thereby enable the student using the personal terminal to study at home.

However, with the correspondence education system using the Internet, it is extremely difficult for the school to determine correctly whether a student actually taking a course is a properly enrolled student, even from data contents obtained from the personal terminal owned by the student.

Thus, it is not only impossible for the school to regularly monitor progress in study of each student but also extremely difficult for the school to conduct a test for checking achievement of the student in real time. Therefore the school cannot grant credits for each course in the same manner as an ordinary college or other educational institution.

### SUMMARY OF THE INVENTION

The present invention has been made in view of the above, and it is accordingly an object of the present invention to propose a correspondence education system and a correspondence education method that can securely provide information to only a person whose personal authentication has been performed.

In order to solve the above problems, according to the present invention, there is provided a correspondence education system in which a terminal apparatus and an information processing apparatus are connected to each other via a network, the correspondence education system including: authentication communication means disposed in the terminal apparatus for performing authentication processing on the basis of human body characteristics of a student and transmitting a predetermined authentication signal to the information processing apparatus via the network only when a positive result of the authentication processing is obtained; and control means disposed in the information processing apparatus for transmitting teaching material data representing lecture contents according to a predetermined educational program to the terminal apparatus via the network on the basis of the authentication signal received from the authentication communication means.

Thereby, with the correspondence education system, only the preregistered student himself/herself can receive the lecture contents supplied from the information processing apparatus by using the terminal apparatus. Thus, even when the student lives in a rural area where public transportation is poor or when the student is a physically disabled person, the student can receive advanced education easily.

Further, according to the present invention, there is provided a correspondence education method in which a terminal apparatus and an information processing apparatus are connected to each other via a network, the correspondence education method including: a first step in the terminal apparatus for performing authentication processing on the basis of human body characteristics of a student and transmitting a predetermined authentication signal to the information processing apparatus via the network only when a positive result of the authentication processing is obtained; and a second step in the information processing apparatus for transmitting teaching material data representing lecture contents according to a predetermined educational program to the terminal apparatus via the network on the basis of the authentication signal received from the terminal apparatus.

Thereby, with the correspondence education method, only the preregistered student himself/herself can receive the lecture contents supplied from the information processing apparatus by using the terminal apparatus. Thus, even when the student lives in a rural area where public transportation is poor or when the student is a physically disabled person, the student can receive advanced education easily.

### BRIEF DESCRIPTION OF THE DRAWINGS

FIG. 1 is a schematic diagram showing a configuration of a correspondence education system according to an embodiment;

FIG. 2 is a block diagram showing an internal configuration of a personal terminal shown in FIG. 1;

FIG. 3 is a conceptual diagram of assistance in explaining a data format of a flash memory within a fingerprint identification unit;

FIG. 4 is a block diagram showing a configuration of a lecture providing server shown in FIG. 1;

FIG. 5 is a conceptual diagram of assistance in explaining a data format of a flash memory within the lecture providing server;

FIG. 6 is a flowchart of assistance in explaining an initial setting processing procedure;

FIG. 7 is a flowchart of assistance in explaining a correspondence course processing procedure;

FIG. 8 is a plan view of an example displayed on a display of the personal terminal;

FIG. 9 is a flowchart of assistance in explaining a test conducting processing procedure; and

FIG. 10 is a plan view of an example displayed on a display of a personal terminal according to another embodiment.

### DETAILED DESCRIPTION OF PREFERRED EMBODIMENTS

A preferred embodiment of the present invention will hereinafter be described in detail with reference to the drawings.

(1) Configuration of Correspondence Education System According to Present Embodiment

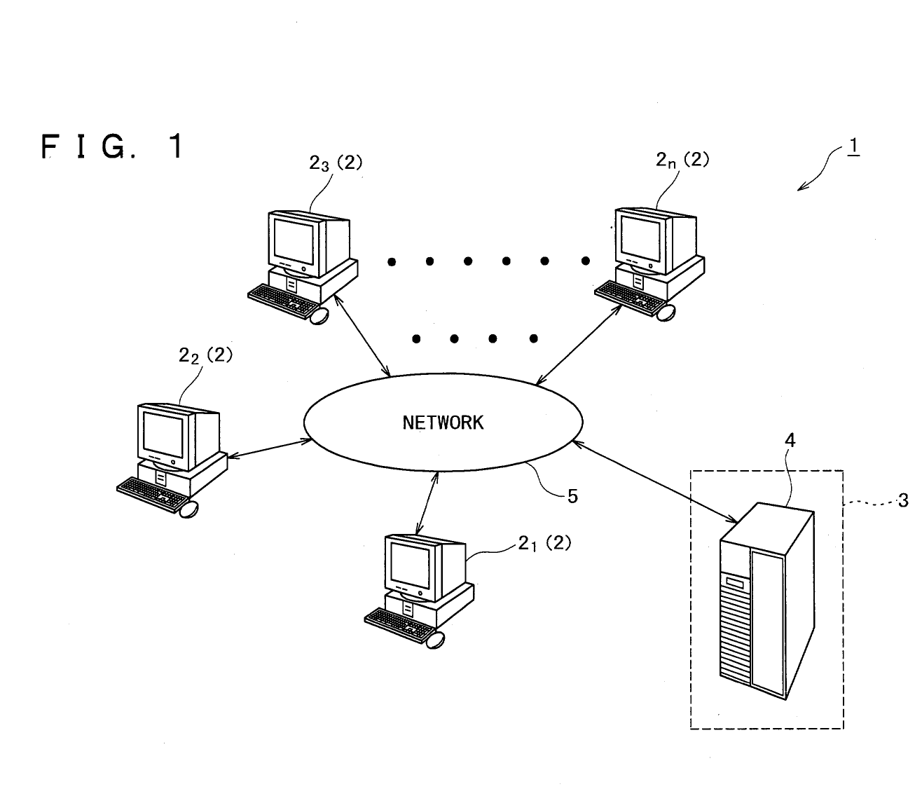

In FIG. 1, reference numeral 1 denotes a correspondence education system as a whole according to the present embodiment. The correspondence education system is formed by connecting a plurality of personal terminals 2 (2₁ to 2ₙ) used by students with a lecture providing server 4 arranged by a school 3 via a network 5.

Each of the personal terminals 2 is an ordinary personal computer installed in an ordinary household or a company. Each of the personal terminals 2 can communicate with the other personal terminals 2 and the lecture providing server 4 via the network 5 to thereby transmit and receive necessary data, and display a Web page screen based on screen data obtained by the communication and the like.

Each of the personal terminals 2 is provided with a fingerprint identification unit 2F for identifying a fingerprint separately from a main unit 2H of the personal computer. The fingerprint identification unit 2F is connected to the main unit 2H via a USB (Universal Serial Bus) interface, for example.

The lecture providing server 4 is a Web server and database server for performing various processing related to various-services as later described that are provided by the school 3. The lecture providing server 4 can communicate with a personal terminal 2 that has accessed the lecture providing server 4 via the network 5 to thereby transmit and receive necessary data.

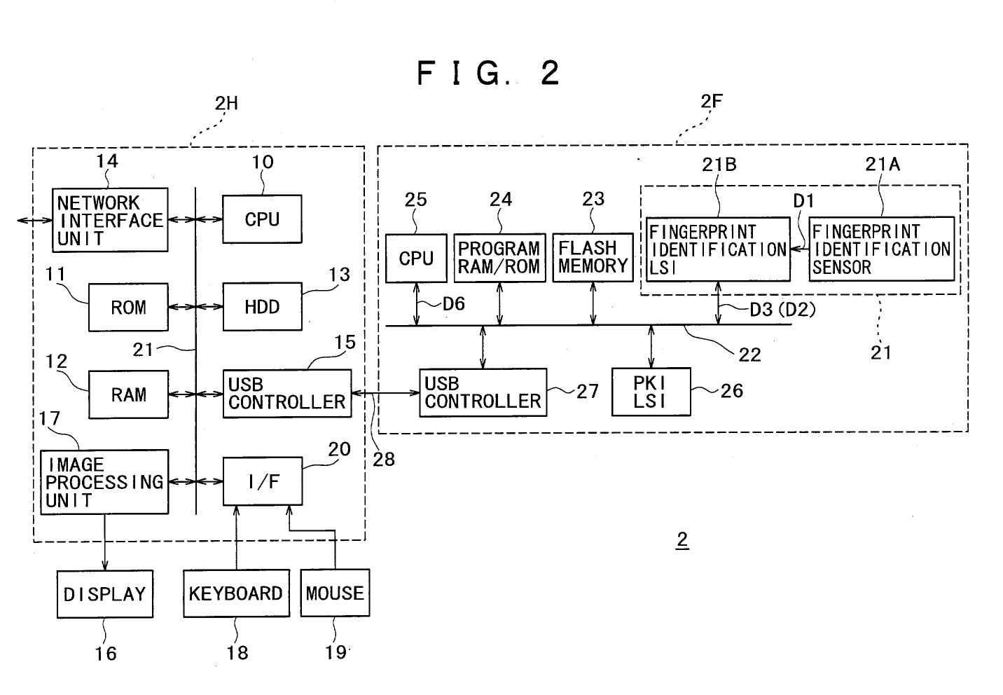

FIG. 2 shows an internal configuration of the main unit 2H of each of the personal terminals 2. The main unit 2H of each of the personal terminals 2 includes: a CPU (Central Processing Unit) 10 for controlling the whole of the main unit 2H; a ROM (Read Only Memory) 11 for storing various software; a RAM (Random Access Memory) 12 as a work memory for the CPU 10; a hard disk drive 13 for storing various data; a network interface unit 14 serving as an interface for the CPU 10 to communicate with the exterior thereof via the network 5; a USB controller 15; an image processing unit 17 to which a display 16 is connected; and an interface unit 20 to which a keyboard 18 and a mouse 19 are connected. The main unit 2H is formed by interconnecting these components via a bus 21.

In this case, the CPU 10 captures via the network interface unit 14 data and a command supplied from a personal terminal 2 that has accessed the personal terminal 2 via the network 5 (FIG. 1), and then performs various processing on the basis of the data and command as well as software stored in the ROM 11.

Then the CPU 10 sends the corresponding personal terminal 2 screen data of a predetermined Web page read from the hard disk drive 13 and data such as another program or command, for example, as a result of the processing via the network interface unit 14.

Thus, the personal terminal 2 can transmit and receive screen data of Web pages and other necessary data to and from the lecture providing server 4 that has accessed the personal terminal 2. Incidentally, a plurality of databases (not shown) are stored in the hard disk drive 13 in the personal terminal 2, so that when various processing is to be performed, necessary information can be read from corresponding databases.

In addition to such a configuration, the fingerprint identification unit 2F of each of the personal terminals 2 includes: a fingerprint identification unit (FIU) 21; a flash memory 23 connected to the fingerprint identification unit 21 via a bus 22; a ROM and RAM 24 for programs; a CPU 25 for controlling the whole of the fingerprint identification unit 2F; a PKI (Public-Key Infrastructure) LST (Large Scale Integration) 26 connected to the CPU 25 via the bus 22; and a USB controller 27. The USB controller 27 is connected to the USB controller 15 within the main unit 2H via a USB 28.

The fingerprint identification unit 21 includes: a fingerprint identification sensor 21A for detecting a fingerprint of a finger of a human; and a fingerprint identification LSI 21B for processing a result of the detection obtained from the fingerprint identification sensor 21A.

The fingerprint identification sensor 21A is formed by a semiconductor sensor (so-called silicon sensor) in which predetermined numbers of semiconductors of an extremely small size are arranged in a vertical and a horizontal direction, respectively (for example 192 semiconductors in the vertical direction and 128 semiconductors in the horizontal direction) in a matrix manner with a predetermined pitch (for example 80 [μm]). When a finger is pressed into contact with a surface of the sensor, capacitance of semiconductors corresponding to the finger changes according to unevenness of a fingerprint of the finger, whereby the fingerprint as a whole is obtained.

Thus, the fingerprint identification sensor 21A detects the capacitance of a plurality of semiconductors situated within a predetermined detection area in a center of the semiconductor sensor, and then sends the capacitance as detection data D1 to the fingerprint identification LSI 21B.

The fingerprint identification LST 21B converts a state of change of the capacitance of the semiconductors into a gray image on the basis of the detection data D1 obtained from the fingerprint identification sensor 21A, and then converts the gray image into binarized data (hereinafter referred to as fingerprint data) D2 corresponding to the unevenness of the fingerprint.

Next, while using the program RAM and ROM 24 as a work memory, the fingerprint identification LSI 21B extracts a part (hereinafter referred to as template data) D3 corresponding to a characteristic point (hereinafter referred to as a template) of the fingerprint from the fingerprint data D2 and then stores the part in the flash memory 23, or compares the fingerprint data D2 with each piece of template data D3 prerecorded in the flash memory 23.

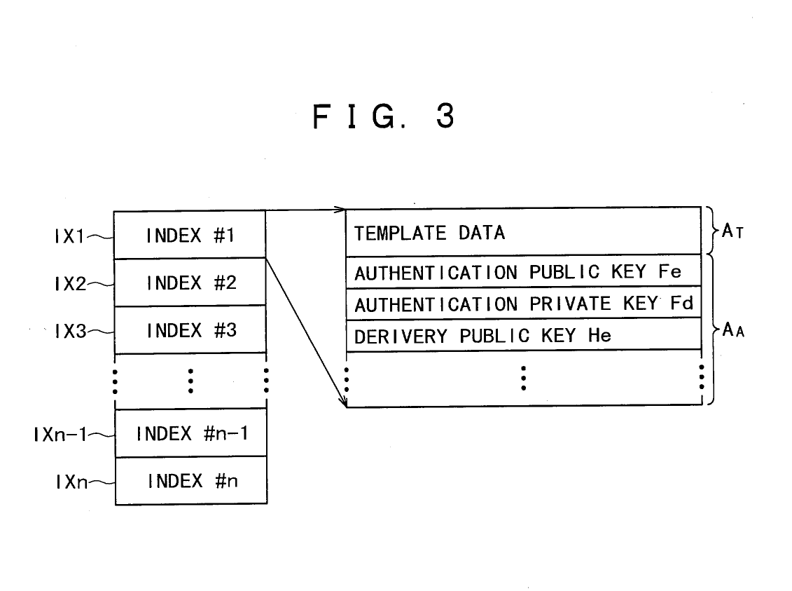

FIG. 3 shows a data format of the flash memory 23. As shown in FIG. 3, one index IX1 to IXn is provided for one fingerprint in the flash memory 23. Each of the indexes IX1 to IXn is divided into two areas: a template area A_{T} and an attribute area A_{A}. The registered template data D3 is stored in the template area A_{T}, and various data associated with the template data D3 (various public and private keys and the like to be described later) is stored in the attribute area A_{A}.

In response to data input from the fingerprint identification LST 21B, the CPU 25 reads a corresponding program from among various programs stored within the flash memory 23, expands the program in the program ROM and RAM 24, and then performs various control processing according to the program.

Also, in response to data input from the fingerprint identification LSI 21B, the CPU 25 generates various cryptographic keys by a cryptographic engine (program) stored in the flash memory 23 when necessary, as later described.

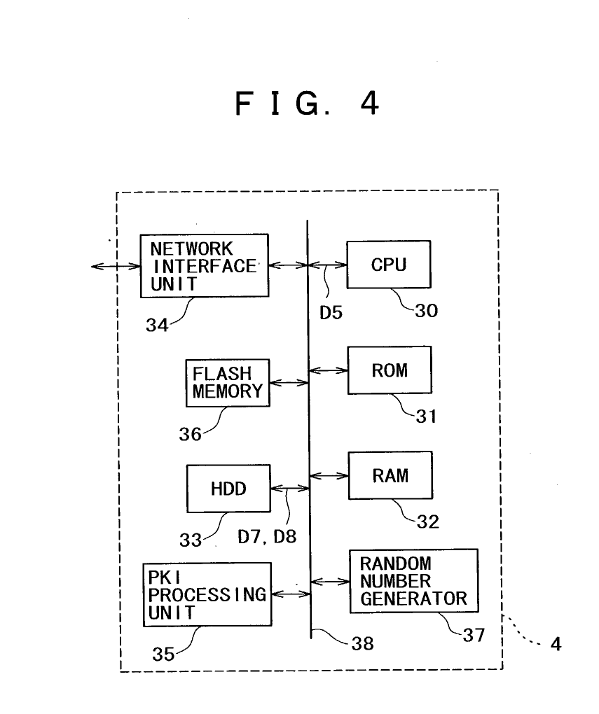

FIG. 4 shows a configuration of the lecture providing server 4. As is clear from FIG. 4, the lecture providing server 4 includes: a CPU 30 for controlling the whole of the lecture providing server 4; a ROM 31 for storing various software; a RAM 32 as a work memory for the CPU 30; a hard disk drive 33 for storing various data; a network interface unit 34 serving as an interface for the CPU 30 to communicate with the exterior thereof via the network 5 (FIG. 1); a PKI LSI 35; a flash memory 36; and a random number generator 37. The lecture providing server 4 is formed by interconnecting these components via a bus 38.

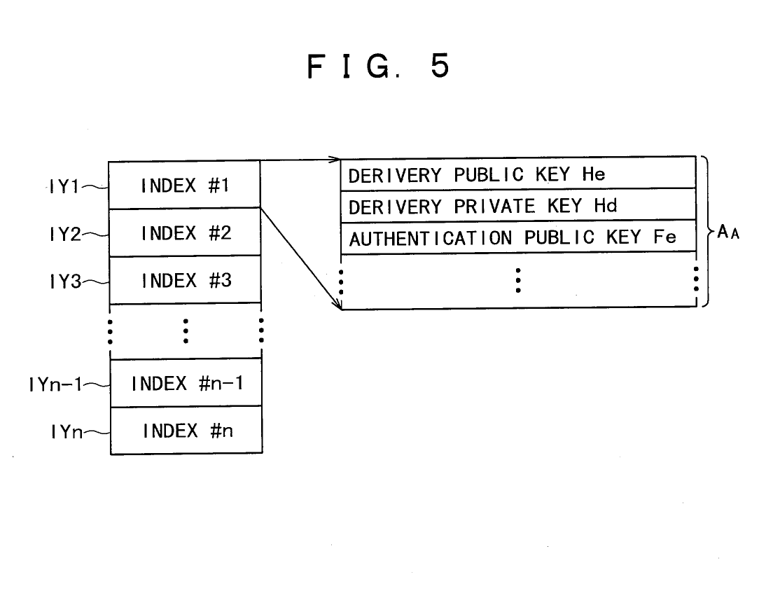

FIG. 5 shows a data format of the flash memory 36. As shown in FIG. 5, one index IY1 to IYn is provided for one fingerprint in the flash memory 36. Each of the indexes IY1 to IYn has an attribute area A_{A}. Various data (various public and private keys and the like to be described later) is stored in the attribute area AA.

In this case, the CPU 30 captures via the network interface unit 34 data and a command supplied from a personal terminal 2 that has accessed the lecture providing server 4 via the network 5 (FIG. 1), and then performs various processing on the basis of the data and command as well as software stored in the ROM 31.

Then the CPU 30 sends the corresponding personal terminal 2 screen data of a predetermined Web page read from the hard disk drive 33 and data such as another program or command, for example, as a result of the processing via the network interface unit 34.

Thus, the lecture providing server 4 can transmit and receive screen data of Web pages and other necessary data to and from the personal terminal 2 that has accessed the lecture providing server 4. Incidentally, a plurality 6f databases (not shown) are stored in the hard disk drive 33 in the lecture providing server 4, so that when various processing is to be performed, necessary information can be read from corresponding databases.

(2) Various Functions of Fingerprint Identification Unit

The fingerprint identification unit 2F has a function of registering a fingerprint of a student, a function of comparing the fingerprint of the student with registered fingerprints, and a function of generating cryptographic keys for the student whose fingerprint is registered.

First, when a finger is pressed into contact with a sensor surface of the fingerprint identification sensor 21A at the time of personal registration of the student on the school side, the CPU 25 in the fingerprint identification unit 2F (FIG. 2) obtains a fingerprint of the finger, and then supplies resulting detection data D1 to the fingerprint identification LSI 21B. The fingerprint identification LSI 21B generates template data D3 from fingerprint data D2 based on the supplied detection data D1, and then stores the template data D3 in a template area A_{T} in a specified index IX1 to IXn of the flash memory 23. The fingerprint of a student is thus registered in each of the personal terminals 2.

Also, when a finger is pressed into contact with the sensor surface of the fingerprint identification sensor 21A, the CPU 25 in the fingerprint identification unit 2F obtains a fingerprint of the finger, and then supplies resulting detection data D1 to the fingerprint identification LSI 21B. The fingerprint identification LSI 21B sequentially compares fingerprint data D2 based on the supplied detection data D1 with template data D3 stored in the template areas A_{T} of all the indexes IX1 to IXn of the flash memory 23, and then sends a result of the comparison to the CPU 25. The fingerprint identification unit 2F thus compares the fingerprint of a student with the registered fingerprints.

The fingerprint identification unit 2F is configured to be able to create and register cryptographic keys for the student only once immediately after the student is authenticated as a registered student by the fingerprint comparison.

The fingerprint identification unit 2F is configured so as to be able to create, as cryptographic keys, not only a pair of a private key and a public key (that will hereinafter be referred to as an authentication private key and an authentication public key, respectively) Fd and Fe for encrypting and decrypting a result of fingerprint authentication that is sent to the lecture providing server 4 side but also a pair of a private key and a public key (that will hereinafter be referred to as a delivery private key and a delivery public key, respectively) Hd and He for delivering the authentication public key to a specific destination in secret, as later described, and register the keys.

In practice, when a finger is pressed into contact with the sensor surface of the fingerprint identification sensor 21A and a fingerprint of the finger is authenticated as that of one of preregistered students, the CPU 25 in the fingerprint identification unit 2F allows an attribute area A_{A} belonging to an index IX1 to IXn corresponding to the fingerprint in the flash memory 23 to be accessed only once.

The CPU 30 of the lecture providing server 4 determines whether or not the student is authenticated as a registered student on the basis of a result of authentication from the personal terminal 2. When the student is not authenticated as a registered student, the CPU 30 ends this processing, while when the student is authenticated as a registered student, the CPU 30 issues a cryptographic key creating and registering command D5 to the CPU 25 of the fingerprint identification unit 2F of the personal terminal 2.

When the cryptographic key creating and registering command D5 is supplied to the CPU 25 of the fingerprint identification unit 2F, the CPU 25 creates an authentication private key Fd and an authentication public key Fe by the cryptographic engine, and stores the authentication private key Fd and the authentication public key Fe in the attribute area A_{A} belonging to the foregoing corresponding index IX1 to IXn via the fingerprint identification LSI 21B.

The CPU 30 of the lecture providing server 4 can similarly create a delivery private key Hd and a delivery public key He, and similarly stores the created delivery private key Hd and delivery public key He in an attribute area A_{A} belonging to a corresponding index IY1 to IYn in the flash memory 36.

Thus, with the fingerprint identification unit 2F of the personal terminal 2, an authentication private key Fd and an authentication public key Fe and a delivery private key Hd and a delivery public key He are created for a student whose fingerprint is registered, and these keys are stored in the flash memory 23 in association with the student.

In the case of the present embodiment, the CPU 30 of the lecture providing server 4 can freely read from the flash memory 36 the authentication public key Fe and the delivery public key He among the authentication private key Fd and the authentication public key Fe and the delivery private key Hd and the delivery public key He stored in the attribute areas A_{A} as described above, whereas the CPU 30 of the lecture providing server 4 cannot read from the flash memory 36 the authentication private key Fd and the delivery private key Hd.

Fundamental principles and use of public key cryptography will be described in the following. In public key cryptography, two keys referred to as a public key and a private key are created as cryptographic keys for encrypting information and decrypting the encrypted information. The public key and the private key have a relation in which information encrypted by one key can be decrypted only by the other key. The public key is disclosed to all people using the system (for example an electronic money system), and the private key is kept by an individual.

In such public key cryptography, each individual encrypts information using his/her private key, and sends resulting information to another person. The other person decrypts the information using a public key of the individual. When information is to be sent from the other person to the individual, the other person encrypts the information using the public key of the individual and sends resulting information to the individual. The individual decrypts the information using his/her private key.

Description will now be made by taking as an example a case where this cryptography is applied specifically to a correspondence course. A student encrypts a course registration owned by only the student by his/her private key and then sends the encrypted course registration to the school 3. The school 3 decrypts the encrypted course registration sent thereto by a public key of the student. When the course registration is decrypted correctly, it is confirmed that the course registration that can be encrypted by only the student in principle has been sent, and therefore this proves that the student really takes the course.

The school 3 sends the student lecture contents encrypted by the public key of the student on the basis of the course registration. The student decrypts the lecture contents by his/her private key.

With such public key cryptography, only when information is encrypted by a private key of a person, the information can be decrypted by a public key of the person in principle. Therefore, such public key cryptography has an advantage of being able to prevent a crime of impersonating another person and a crime of denying having placed an order.

In addition, with public key cryptography, information encrypted by a public key of a person can be decrypted only by a private key of the person in principle. Therefore, public key cryptography has an advantage of being able to effectively and surely prevent a crime such as changing the above-mentioned lecture contents while the lecture contents pass many points on the Internet, for example.

(3) Personal Registration of Student in Correspondence Education System

In practice, with the correspondence education system 1, a student goes to a service window of the school 3 in person, and submits an identification of the student such for example as a driver's license for personal registration. The student then registers his/her fingerprint with the above-described fingerprint identification unit 2F and registers his/her electronic mail address and user ID with the lecture providing server 4.

The school 3 registers in advance a delivery private key He in the fingerprint identification unit 2F, while the CPU 30 of the lecture providing server 4 reads an authentication public key Fe of the student registered in the fingerprint identification unit 2F and then stores the authentication public key Fe in the flash memory 36 within the lecture providing server 4. The school 3 then lends the fingerprint identification unit 2F to the student, whereby initial setting is completed.

Thereafter, in a step4, it suffices to connect the fingerprint identification unit 2F lent by the school 3 to the main unit 2H of the personal terminal 2 of the student whose personal registration has been made. At this time, the delivery public key He of the lecture providing server 4 is already stored in the flash memory 23 within the fingerprint identification unit 2F.

The authentication public key Fe obtained by the student at the time of the personal registration is already stored in the flash memory 36 within the lecture providing server 4.

(4) Initial Setting Processing of Correspondence Education System

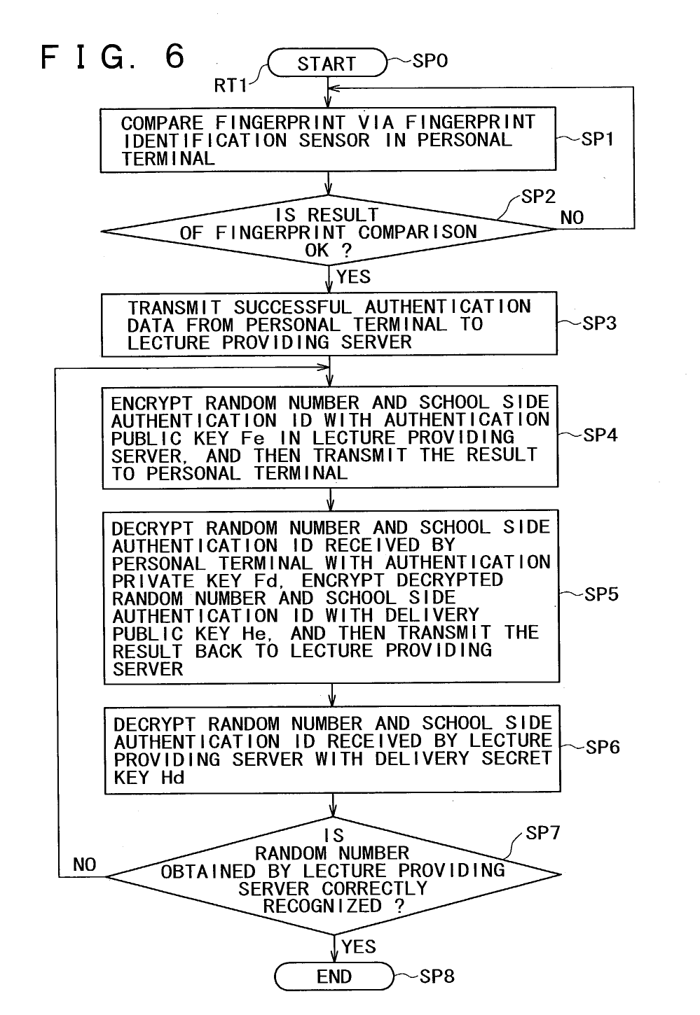

Thereafter, the correspondence education system 1 starts an initial setting processing procedure RT1 shown in FIG. 6 at a step SP0. At a next step SP1, the personal terminal 2 compares the fingerprint of the student pressed into contact with the sensor surface of the fingerprint identification sensor 21A of the fingerprint identification unit 2F with preregistered fingerprints. The processing then proceeds to a step SP2.

When it is determined at the step SP2 that a result of the comparison is OK, the processing proceeds to a step SP3, where the CPU 25 within the fingerprint identification unit 2F transmits data (hereinafter referred to as successful authentication data) D6 indicating that a result of authentication of the student is OK to the lecture providing server 4 via the network 5.

At a next step SP4, on the basis of the successful authentication data D6 received by the lecture providing server 4, the CPU 30 in the lecture providing server 4 controls the random number generator 37 to generate an appropriate random number (for example “RN”) as a key of DES (Data Encryption Standard), a cryptographic algorithm of common key cryptography. Also, the CPU 30 reads a predetermined authentication ID (hereinafter referred to as a school side authentication ID) (for example “ABC”) from the flash memory 36. The CPU 30 encrypts the random number and the school side authentication ID with the authentication public key Fe of the personal terminal 2 (“RN”+“ABC”)^{Fe}, and then transmits the result to the corresponding personal terminal 2 via the network.

At a step SP5, the CPU 25 within the fingerprint identification unit 2F of the personal terminal 2 decrypts the random number and the school side authentication ID (“RN”+“ABC”)^{Fe} received by the personal terminal 2 by an authentication private key Fd of the fingerprint identification unit 2F, and checks the school side authentication ID (“RN”+“ABC”)^{Fd} obtained as a result of the decryption. At this time, when “ABC” is correctly recognized as the school side authentication ID, it means that the personal terminal 2 has correctly received the delivery public key He of the lecture providing server 4.

Next, the CPU 25 within the fingerprint identification unit 2F encrypts the decrypted random number and school side authentication ID (“RN”+“ABC”)^{Fd} by the delivery public key He of the lecture providing server 4 [(“RN”+“ABC”)^{Fd}]^{He}, and then transmits the result back to the lecture providing server 4 via the network 5.

Thus, at a step SP6, the CPU 30 in the lecture providing server 4 decrypts the random number and the school side authentication ID [(“RN”+“ABC”)^{Fd}]^{He} received by the lecture providing server 4 by a delivery private key Hd of the lecture providing server 4, and checks the random number among the random number and the school side authentication ID [(“RN”+“ABC”)^{Fd}]^{Hd} obtained as a result of the decryption.

At this time, when “RN” is correctly recognized as the random number at a step SP7, it means confirmation that the student already registered in the lecture providing server 4 operated his/her personal terminal 2.

When a positive result is obtained at the step SP7, on the basis of such a result of authentication of the valid student, the CPU 30 within the lecture providing server 4 can securely perform communication between the lecture providing server 4 and the corresponding personal terminal 2 by using the random number “RN” as a key of DES, or a cryptographic algorithm of common key cryptography. The processing proceeds directly to a step SP8 to end the processing procedure RT1.

When “RN” is not correctly recognized as the random number at the step SP7, on the other hand, the processing returns to the step SP4 for the lecture providing server 4 to perform the same processing as described above. Incidentally, when the processing from the step SP4 to the step SP7 is repeated a predetermined number of times or more, or when a predetermined time has passed, the lecture providing server 4 displays an error message on the display 16 of the personal terminal 2 to inform the student operating the personal terminal 2 of an error.

In subsequent processing, it is assumed that the initial setting processing described thus far has been performed and that all communications between the lecture providing server 4 and the personal terminal 2 are encrypted unless otherwise specified.

(5) Correspondence Course Processing of Correspondence Education System

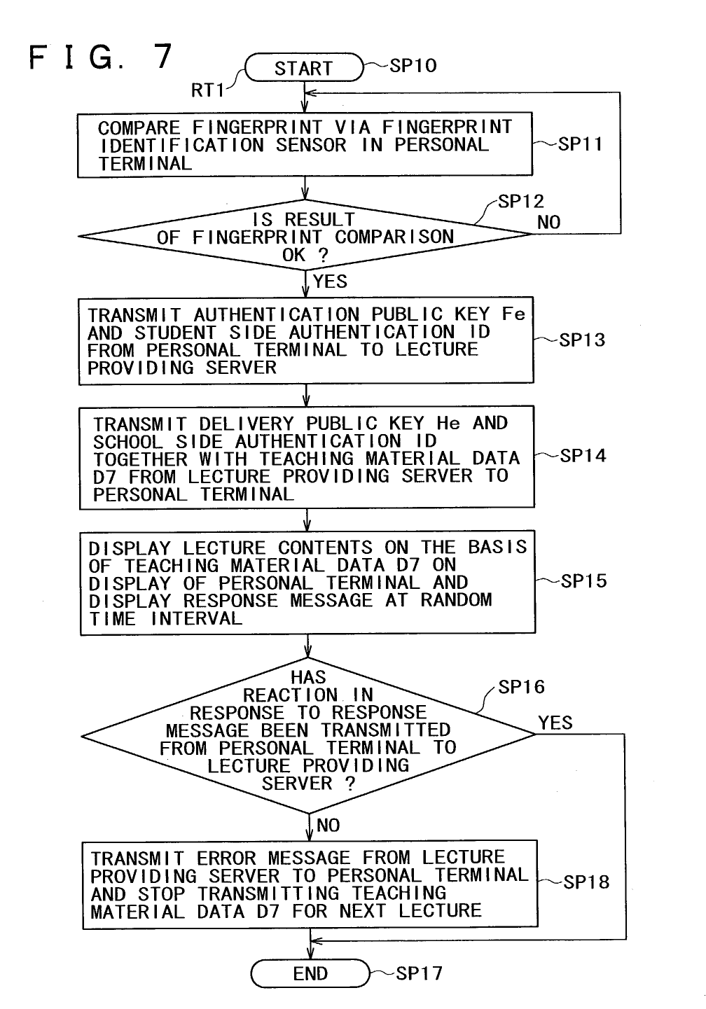

Thereafter, the correspondence education system 1 starts an correspondence course processing procedure RT2 shown in FIG. 7 at a step SP10. At a next step SP11, when the student presses a preregistered finger into contact with the sensor surface of the fingerprint identification sensor 21A of the fingerprint identification unit 2F as required, the fingerprint of the student pressed into contact with the sensor surface of the fingerprint identification sensor 21A is compared with preregistered fingerprints. The processing then proceeds to a step SP12.

When it is determined at the step SP12 that a result of the comparison is OK, the processing proceeds to a step SP13, where the CPU 25 within the fingerprint identification unit 2F reads the authentication public key Fe and a predetermined authentication ID (hereinafter referred to as a student side authentication ID) from the flash memory 23, and then transmits the authentication public key Fe and the student side authentication ID to the lecture providing server 4.

At a step SP14, when the lecture providing server 4 receives the authentication public key Fe and the student side authentication ID from the personal terminal 2 of the student, the CPU 30 within the lecture providing server 4 reads the delivery public key He and the school side authentication ID from the flash memory 36 and reads data (hereinafter referred to as teaching material data) D7 describing lecture contents for one lecture according to the correspondence course from the hard disk drive 33 in response to the reception of the authentication public key Fe and the student side authentication ID, and then transmits the delivery public key He, the school side authentication ID, and the teaching material data D7 together to the personal terminal 2 via the network 5.

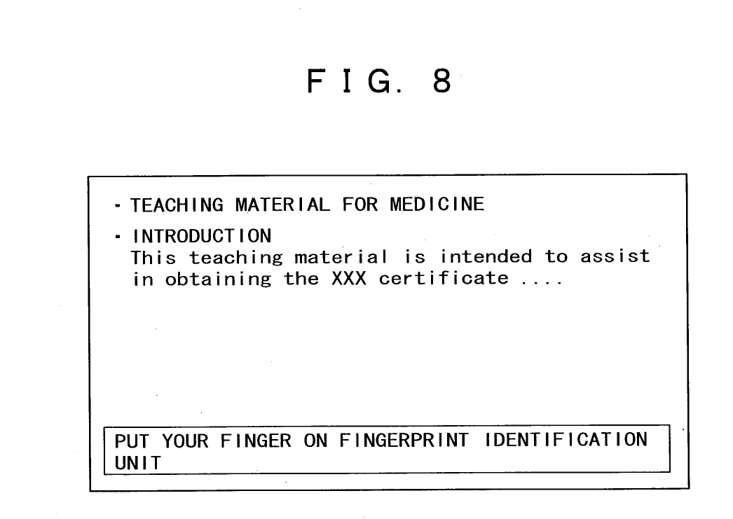

At a next step SP15, as shown in FIG. 8, the personal terminal 2 displays on a screen of the display 16 the lecture contents on the basis of the teaching material data D7 transmitted from the lecture providing server 4. In this case, in addition to the lecture contents, a response message that “Put your finger on the fingerprint identification unit” is displayed at a predetermined position on the display 16 at a random (that is, unpredictable by the student) time interval specified by the school 3.

At a step SP16, the lecture providing server 4 determines whether the authentication public key Fe and the student side authentication ID have been transmitted on the basis of a result of comparison of the finger from the student via the network 5 within a predetermined time (for example within 10 seconds) after starting the display of the response message. When a positive result is obtained, the processing proceeds to a step SP17 to end the processing procedure RT2.

When a negative result is obtained at the step SP16, on the other hand, it indicates that the student is not taking the course or that a person other than the student is taking the course. In this case, the lecture providing server 4 proceeds to a step SP18 to transmit an error message to the personal terminal 2 and stop transmitting teaching material data D7 for a next lecture. The processing-then proceeds to the step SP17 to end the processing procedure RT2.

Thus, with the correspondence education system 1, only the properly registered student can sequentially take lectures provided from the school 3 according to the correspondence course while using his/her personal terminal 2.

(6) Conducting Test in Correspondence Course

Further, with the correspondence education system 1, with an end of each lecture in the correspondence course, the school 3 can make a student take a test related to the lecture as a condition for completing the course.

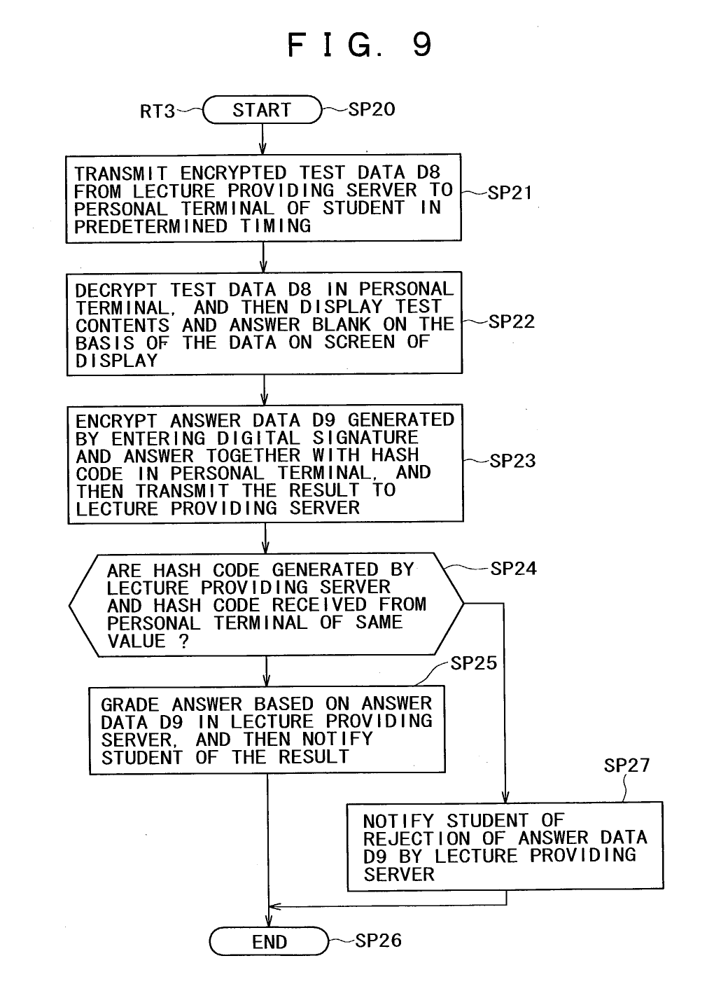

The correspondence education system 1 starts, at a step SP20, a test conducting processing procedure RT3 shown in FIG. 9 following the correspondence course processing procedure RT2 shown in FIG. 7. At a next step SP21, the CPU 30 within the lecture providing server 4 reads data (hereinafter referred to as test data) D8 describing test contents and an answer blank corresponding to the lecture from the hard disk drive 33 when a predetermined time has passed after transmission of teaching material data D7 corresponding to the lecture or at a date specified in advance. The CPU 30 encrypts the test data D8 with the authentication public key Fe of public key cryptography described above, and then transmits the test data D8 to the personal terminal 2 of the student via the network 5.

At a step SP22, the fingerprint identification unit 2F of the personal terminal 2 of the student decrypts the test data D8 received from the lecture providing server 4 with the authentication private key Fd of the fingerprint identification unit 2F, and then displays the test contents and answer blank on the basis of the test data D8 on the screen of the display 16.

At a next step SP23, the student first puts his/her digital signature in the answer blank displayed on the display 16, and enters an answer in the answer blank using the mouse 19 and the keyboard 18 while viewing the test contents, thereby generating data (hereinafter referred to as answer data) D9 representing the answer in the answer blank.

The CPU 25 within the fingerprint identification unit 2F of the personal terminal 2 owned by the student subjects the answer data D9 to compression processing by an arithmetic method using a predetermined Hash function, and thereby generates Hash code. The CPU 25 encrypts the Hash code together with the answer data D9 with the authentication private key Fd of the student, and then transmits the result to the lecture providing server 4 via the network 5.

At a step SP24, after decrypting the Hash code and the answer data D9 received by the lecture providing server 4 with the authentication public key Fe of the student, the lecture providing server 4 generates Hash code corresponding to the answer data D9, and then determines whether or not the Hash code generated by the lecture providing server 4 and the Hash code received from the student are of the same value.

When a result of the determination at the step SP24 is positive, the lecture providing server 4 can verify that the answer data D9 has certainly been transmitted from the student himself/herself and that the answer contents have not been altered in the transmission process. Proceeding to a step SP25, the lecture providing server 4 grades the answer based on the answer data D9 received from the student, and then notifies the corresponding student of a grade corresponding to a result of the grading. The processing thereafter proceeds directly to a step SP26 to end the processing procedure RT3.

When the result of the determination at the step SP24 is negative, on the other hand, the lecture providing server 4 determines that the received answer data D9 has not been transmitted by the preregistered student himself/herself. Proceeding to a step SP27 without accepting the answer data D9, the lecture providing server 4 notifies the personal terminal of the real student himself/herself of the rejection. The processing thereafter proceeds to the step SP26 to end the processing procedure RT3.

(7) Operation and Effects of Present Embodiment

With the above configuration, the correspondence education system 1 allows the authentication public key Fe and the delivery public key He to be shared in advance between the personal terminal 2 of the student whose personal registration has been made and the lecture providing server 4 of the school 3. Only when a result of fingerprint comparison by the student using the fingerprint identification unit 2F of the personal terminal 2 indicates that the fingerprint of the student matches a fingerprint of a preregistered student, digital authentication by public key cryptography is performed between the personal terminal 2 and the lecture providing server 4.

When the lecture providing server 4 confirms as a result of the digital authentication that the already registered'student has operated the personal terminal 2, the lecture providing server 4 transmits lecture contents for one lecture according to the correspondence course as teaching material data D7 to the corresponding personal terminal 2. Thereby, only the preregistered student himself/herself can take the lecture based on the teaching material data D7 using the personal terminal 2.

Further, the correspondence education system 1 not only supplies the lecture contents from the school 3 but also makes the student himself/herself take a test with an end of each lecture and transmits a result of the test obtained from the student to the lecture providing server 4 in a state in which the result of the test is encrypted using Hash code. Thereby, the result of the test can be securely submitted from the student himself/herself to the school 3 while the data is prevented from being altered from the outside. Consequently the student can take a credit according to grades on test results, and thereafter when the student has completed all of the correspondence course, it is possible to issue a diploma of the school and thus grant the student a similar certificate to that obtained at graduation from an ordinary school.

Thus, with the correspondence education system 1, the student whose personal registration has been made can receive, while at home, the same education as received by going to the school. Even when the student lives in a rural area where public transportation is poor or when the student is a physically disabled person or the like, the student can receive advanced education easily.

With the above configuration, the fingerprint identification unit 2F is provided to the personal terminal 2 in the correspondence education system 1, and after fingerprint comparison by the student using the personal terminal 2, digital authentication by public key cryptography is performed between the personal terminal 2 and the lecture providing server 4. Thereby, only the preregistered student himself/herself can receive the lecture contents supplied from the school 3. Consequently, even when the student lives in a rural area where public transportation is poor or when the student is a physically disabled person, the student can receive advanced education easily. It is thus possible to realize the correspondence education system 1 that can securely provide lecture contents to only students themselves whose personal registration has been made.

(8) Other Embodiments

It is to be noted that while in the foregoing embodiment; the present invention as applied to the correspondence education system 1 formed as in FIG. 1 that includes the personal terminals (terminal apparatus) 2 and the lecture providing server (information processing apparatus) 4 has been described, the present invention is not limited to this, and is widely applicable to communication systems of various other configurations according to other embodiments.

Also, the foregoing embodiment has dealt with a case where the correspondence education system 1 is constructed by applying the fingerprint identification unit 2F of the personal terminal 2 as shown in FIG. 2 as authentication communication means that authenticates a student on the basis of human body characteristics of the student and then outputs successful authentication data (authentication signal) D6 only when a positive result of the authentication is obtained, and by applying the lecture providing server 4 of the school as shown in FIG. 4 as control means that transmits teaching material data D7 representing lecture contents according to a predetermined educational program on the basis of the authentication signal received from the authentication communication means. However, the present invention is not limited to this, and is widely applicable to various other authentication communication means and control means as long as the student having the terminal apparatus can receive the teaching material data D7 while at home. The predetermined educational program of control means in such a case may be set or constructed freely according to an educational policy or the like of the school and use of the correspondence education system.

In addition, while the foregoing embodiment has dealt with a case where the fingerprint identification unit 2F as authentication communication means is configured to authenticate a student on the basis of human body characteristics of the student and then output successful authentication data (authentication signal) D6 only when a positive result of the authentication is obtained, the present invention is not limited to this, and is widely applicable to authentication communication means of various other configurations.

In such a case, while the fingerprint identification unit 21 for comparing a fingerprint of a finger of a student with preregistered fingerprints is used as the authentication communication means for authenticating the student on the basis of human body characteristics of the student, the present invention is widely applicable to devices of various configurations for making various other biometric identifications. Human body characteristics of a student used in such a case include a fingerprint, a voice print, a pattern of the retina, a pattern of the iris, hand size, speed or stroke pressure of a pen when the student signs, and the like.

Furthermore, while the foregoing embodiment has dealt with a case where the personal terminals (terminal apparatus) 2 and the lecture providing server (information processing apparatus) 4 are connected to each other via the network 5 such as the Internet, the present invention is not limited to this, and is widely applicable not only to wire communication networks such as public lines, a LAN (Local Area Network) and the like but also to networks formed by radio communication networks.

Further, in the foregoing embodiment, description has been made of a case where the CPUs 25 and 30 of each of the personal terminals 2 and the lecture providing server 4 perform digital authentication by public key cryptography between the personal terminal 2 and the lecture providing server 4 using the authentication private key (first private key) Fd and the authentication public key (first public key) Fe created by the personal terminal 2 and the delivery private key (second private key) Hd and the delivery public key (second public key) He created by the lecture providing server 4. However, the present invention is not limited to this, and is widely applicable to digital authentication using other cryptography.

Further, while in the foregoing embodiment, description has been made of a case where when a student makes personal registration, the student goes to a service window of the school 3 in person, and submits an identification of the student such for example as a driver's license for personal registration, the school side 3 may visit a home of the student to make personal registration of the student at home.

Further, while in the foregoing embodiment, description has been made of a case where the student exchanges various data with the lecture providing server 4 of the school 3 via the network 5 such as the Internet while using the personal terminal 2, the various data may be exchanged by remote operation using a so-called video conferencing system between the personal terminal 2 and the lecture providing server 4.

In such a case, the lecture providing server 4 allows not only the fingerprint but also the face of the student himself/herself using the personal terminal 2 to be visually checked, thus enabling still more reliable personal identification. In addition, when data is exchanged in real time, it is possible to monitor the student by images and sound to see that no one is present around the student. Therefore a test or the like can be conducted fairly without cheating.

Further, in the foregoing embodiment, description has been made of a case where the student preregisters the fingerprint of a specific finger using the fingerprint identification unit 2F; however, the present invention is not limited to this. In a case where a test or the like is conducted in real time, when a plurality of fingers (between two to 10 inclusive) are preregistered, setting of operating keys according to a number of fingers whose fingerprints are registered enables setting of a wide variety of operations for correspondingly high reliability of personal authentication.

When a multiple-choice test question is given, the choices may be made to correspond to a plurality of respective registered fingers so that an answer is determined by a fingerprint put on the fingerprint identification sensor 21A. Specifically, at SP22, index numbers of the corresponding indexes IX1 to IXn in FIG. 3 or names of the indexes preregistered in the flash memory 23 in association with the indexes IX1 to IXn at the time of fingerprint registration are displayed as the test question in correspondence with the choices. Then, at SP23, the fingerprint put on the fingerprint identification sensor 21A is compared with template data AT of the indexes, and index IX identifying information of an identified index IX and its Hash value are encrypted by an authentication private key Fd stored in an attribute area A_{A} of the index IX and then transmitted to the lecture providing server 4 via the personal terminal 2 together with the index number. In this case, the index IX identifying information is a random number generated at the time of registration, and is stored in the corresponding index IX in the flash memory 23 of the fingerprint identification unit 2F and the corresponding index IX in the flash memory 36 of the lecture providing server 4. Thereafter, receiving the index number and the information encrypted with the authentication private key Fd from the personal terminal 2, the lecture providing server 4 at SP24 decrypts the information by an authentication public key Fe of the index IX corresponding to the index number. When the decrypted Hash value and index IX identifying information coincide with the above Hash value and index IX identifying information, the processing proceeds to SP25, whereas when the decrypted Hash value and index IX identifying information do not coincide with the above Hash value and index IX identifying information, the processing proceeds to SP27. Subsequent processing is the same as described above.

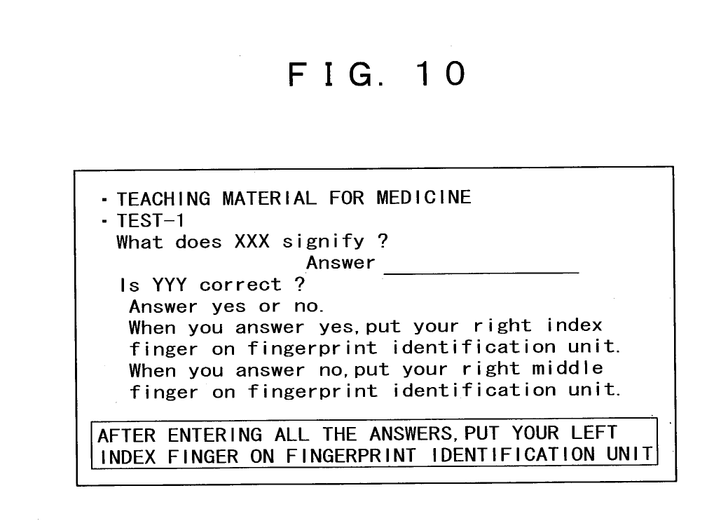

For example, as shown in FIG. 10, the personal terminal 2 displays lecture contents on the basis of teaching material data D7 transmitted from the lecture providing server 4 on the screen of the display 16. At this time, in addition to the lecture contents, a response message that “After entering all the answers, put your left index finger on the fingerprint identification unit” may be displayed at a predetermined position on the display 16 at a random (that is, unpredictable by the student) time interval specified by the school 3.

As described above, according to the present invention, a correspondence education system in which a terminal apparatus and an information processing apparatus are connected to each other via a network includes: authentication communication means disposed in the terminal apparatus for performing authentication processing on the basis of human body characteristics of a student and transmitting a predetermined authentication signal to the information processing apparatus via the network only when a positive result of the authentication processing is obtained; and control means disposed in the information processing apparatus for transmitting teaching material data representing lecture contents according to a predetermined educational program to the terminal apparatus via the network on the basis of the authentication signal received from the authentication communication means. Thereby, only the preregistered student himself/herself can receive the lecture contents supplied from the information processing apparatus by using the terminal apparatus. Consequently, even when the student lives in a rural area where public transportation is poor or when the student is a physically disabled person, the student can receive advanced education easily. It is thus possible to realize the correspondence education system that can securely provide information to only the student whose personal authentication has been performed.

Further, according to the present invention, a correspondence education method in which a terminal apparatus and an information processing apparatus are connected to each other via a network includes: a first step in the terminal apparatus for performing authentication processing on the basis of human body characteristics of a student and transmitting a predetermined authentication signal to the information processing apparatus via the network only when a positive result of the authentication processing is obtained; and a second step in the information processing apparatus for transmitting teaching material data representing lecture contents according to a predetermined educational program to the terminal apparatus via the network on the basis of the authentication signal received from the terminal apparatus. Thereby, only the preregistered student himself/herself can receive the lecture contents supplied from the information processing apparatus by using the terminal apparatus. Consequently, even when the student lives in a rural area where public transportation is poor or when the student is a physically disabled person, the student can receive advanced education easily. It is thus possible to realize the correspondence education method that can securely provide information to only the student whose personal authentication has been performed.

What is claimed is:

1. A correspondence education system in which a terminal apparatus and an information processing apparatus are connected to each other via a network, said correspondence education system comprising:
authentication communication means disposed in said terminal apparatus for performing authentication processing on the basis of human body characteristics of a student and transmitting a predetermined authentication signal to said information processing apparatus via said network only when a positive result of the authentication processing is obtained; and
control means disposed in said information processing apparatus for transmitting teaching material data representing lecture contents according to a predetermined educational program to said terminal apparatus via said network on the basis of said authentication signal received from said authentication communication means.

2. A correspondence education system as claimed in claim 1,
wherein said authentication communication means creates a first public key and a first private key by public key cryptography and then supplies said first public key to said control means, while said control means creates a second public key and a second private key by said public key cryptography and then supplies said second public key to said authentication communication means;
said control means encrypts predetermined information with said first public key on the basis of said authentication signal outputted from said authentication communication means, and then transmits the information to said authentication communication means;
said authentication communication means decrypts the information encrypted with said first public key with said first private key, and then encrypts the information with said second public key and transmits the information to said control means; and
said control means transmits said teaching material data to said terminal apparatus on the basis of the information encrypted with said second public key.

3. A correspondence education method in which a terminal apparatus and an information processing apparatus are connected to each other via a network, said correspondence education method comprising:
a first step in said terminal apparatus for performing authentication processing on the basis of human body characteristics of a student and transmitting a predetermined authentication signal to said information processing apparatus via said network only when a positive result of the authentication processing is obtained; and
a second step in said information processing apparatus for transmitting teaching material data representing lecture contents according to a predetermined educational program to said terminal apparatus via said network on the basis of said authentication signal received from said terminal apparatus.

4. A correspondence education method as claimed in claim 3,
wherein said terminal apparatus creates a first public key and a first private key by public key cryptography and then supplies said first public key to said information processing apparatus, while said information processing apparatus creates a second public key and a second private key by said public key cryptography and then supplies said second public key to said terminal apparatus; and
in said second step, when predetermined information is encrypted with said first public key and sent back on the basis of said authentication signal received from output means, said terminal apparatus decrypts the information encrypted with said first public key with said first private key, and then encrypts the information with said second public key generated by said information processing apparatus by said public key cryptography and transmits the information to said information processing apparatus.

5. An information processing apparatus connected via a network to a terminal apparatus connected with an identification unit in a correspondence education system, said information processing apparatus comprising:
storing means for storing a second cryptographic key corresponding to a first cryptographic key stored in association with registration data based on physical characteristics of a user, the first cryptographic key being stored in said identification unit; and
decrypting means for decrypting predetermined transmission information encrypted by said first cryptographic key, the transmission information being generated on the basis of an identification of the physical characteristics of said user obtained by said identification unit and the transmission information being received from said identification unit via said terminal apparatus, by said second cryptographic key corresponding to said first cryptographic key.

6. An information processing apparatus as claimed in claim 5,
wherein said first cryptographic key and said second cryptographic key are a private key and a public key, respectively, in public key cryptography.

7. An information processing apparatus as claimed in claim 5, further comprising:
authenticating means for authenticating said user on the basis of said predetermined transmission information transmitted from said identification unit via said terminal apparatus; and
transmitting means for transmitting teaching material data to said terminal apparatus only when said user is authenticated by said authenticating means.

8. An information processing apparatus as claimed in claim 5, further comprising:
transmitting means for transmitting teaching material data to said terminal apparatus;
said predetermined transmission information including input information inputted in said terminal apparatus on the basis of said teaching material data; and
determining means for determining an answer to said teaching material data transmitted by said transmitting means, on the basis of said input information included in said predetermined transmission information decrypted by said decrypting means.

9. An information processing apparatus as claimed in claim 5, further comprising:
transmitting means for transmitting teaching material data to said terminal apparatus;
said predetermined transmission information including identifying information for identifying said registration data identified by said identification unit among a plurality of pieces of said registration data; and
determining means for determining an answer to said teaching material data transmitted by said transmitting means, on the basis of said identifying information included in said predetermined transmission information decrypted by said decrypting means.

10. A method of an information processing apparatus, said information processing apparatus being connected via a network to a terminal apparatus connected with an identification unit in a correspondence education system, said method comprising:
a storing step for storing a second cryptographic key corresponding to a first cryptographic key stored in association with registration data based on physical characteristics of a user, the first cryptographic key being stored in said identification unit; and
a decrypting step for decrypting predetermined transmission information encrypted by said first cryptographic key, the transmission information being generated on the basis of an identification of the physical characteristics of said user obtained by said identification unit and the transmission information being received from said identification unit via said terminal apparatus, by said second cryptographic key corresponding to said first cryptographic key.

11. A program of an information processing apparatus, said information processing apparatus being connected via a network to a terminal apparatus connected with an identification unit in a correspondence education system, said program comprising:
a storing step for storing a second cryptographic key corresponding to a first cryptographic key stored in association with registration data based on physical characteristics of a user, the first cryptographic key being stored in said identification unit; and
a decrypting step for decrypting predetermined transmission information encrypted by said first cryptographic key, the transmission information being generated on the basis of an identification of the physical characteristics of said user obtained by said identification unit and the transmission information being received from said identification unit via said terminal apparatus, by said second cryptographic key corresponding to said first cryptographic key.

12. An identification unit connected to a terminal apparatus, said terminal apparatus being connected to an information processing apparatus via a network, said identification unit comprising:
storing means for storing registration data based on physical characteristics of a user and an encryption key in association with each other;
obtaining means for obtaining physical characteristics of a user and generating comparison data based on the physical characteristics of said user;
determining means for comparing said registration data stored in said storing means with said comparison data obtained by said obtaining means and thereby determining whether said registration data stored in said storing means and said comparison data obtained by said obtaining means coincide with each other;
encrypting means for encrypting predetermined transmission information with said encryption key when said determining means determines that said registration data and said comparison data coincide with each other; and
transmitting means for transmitting said transmission information encrypted by said encrypting means to said information processing apparatus via said terminal apparatus.

13. An identification unit as claimed in claim 12,
wherein the encryption key stored in said storing means is a private key in public key cryptography, a public key corresponding to the private key being stored in said information processing apparatus; and
said identification unit further comprises access control means for allowing access to said private key only when said determining means determines that said registration data and said comparison data coincide with each other.

14. An identification unit as claimed in claim 12,
wherein said predetermined transmission information is authentication information received in advance from said information processing apparatus via said terminal apparatus in association with information supplied from said information processing apparatus to said terminal apparatus.

15. An identification unit as claimed in claim 12,
wherein said predetermined transmission information is information generated from information inputted into said terminal apparatus by said user on the basis of information transmitted from said information processing apparatus and presented on said terminal apparatus, and transmitted from said terminal apparatus.

16. An identification unit as claimed in claim 12,
wherein said storing means further stores identifying information for identifying a plurality of pieces of said registration data in association with each of the pieces of said registration data; and
said encrypting means encrypts, as said predetermined transmission information, said identifying information stored by said storing means in association with said registration data which said determining means determines coincides with said comparison data.

17. A method of an identification unit, said identification unit being connected to a terminal apparatus, said terminal apparatus being connected to an information processing apparatus via a network, said method comprising:
a storing step for storing registration data based on physical characteristics of a user and an encryption key in association with each other;
an obtaining step for obtaining physical characteristics of a user and generating comparison data based on the physical characteristics of said user;
a determining step for comparing said registration data stored at said storing step with said comparison data obtained at said obtaining step and thereby determining whether said registration data stored at said storing step and said comparison data obtained at said obtaining step coincide with each other;
an encrypting step for encrypting predetermined transmission information with said encryption key when it is determined at said determining step that said registration data and said comparison data coincide with each other; and
a transmitting step for transmitting said transmission information encrypted at said encrypting step to said information processing apparatus via said terminal apparatus.
